(19) United States
(12) Patent Application Publication
(10) Pub. No.: US 2012/0043850 A1
(43) Pub. Date: Feb. 23, 2012

(54) ELECTRICAL ROTARY JOINT

(76) Inventors: Boying B. ZHANG, Lawrenceville, NJ (US); Hong Zhang, North Brunswick, NJ (US); Louis D. Violante, Monroe Township, NJ (US)

(21) Appl. No.: 13/185,749

(22) Filed: Jul. 19, 2011

Related U.S. Application Data
(60) Provisional application No. 61/376,081, filed on Aug. 23, 2010.

(51) Int. Cl. H01R 39/28

(52) U.S. Cl. 310/219

(57) ABSTRACT

A simple planetary or epicyclic gear mechanism consists of a sun gear in the center, an internal or ring gear with a common axis with sun gear, and at least one planet gear. The planet gear is located between the sun gear and ring gear, and meshes with both the sun gear and the ring gear. If the ring gear is stationary, when sun gear rotates, the planet gear not only rotates about its axis, its axis also rotate around the axis of sun gear. In stead of employing the sliding motion between the ring and the brush in electrical slip ring, the current invention makes use of a plurality of conductive gears, particularly a planetary gear mechanism, to transfer electrical power, and/or signal(s) between relatively rotatable objects.

This application claims priority of U.S. Provisional Patent Application No. 61/376,081 filed date: Aug. 23, 2010.

### FIELD OF THE INVENTION

This invention relates to an electrical rotary joint, or electrical slip ring, and more particularly to an apparatus having a plurality of conductive gears to transfer electrical power, and/or signal(s) between relatively rotatable objects.

### BACKGROUND OF THE INVENTION

Electrical rotary joints, or electrical slip rings are electromechanical devices that consist of rotational (rotors) and stationary (stators) members. They allow the transmission of electrical signals and power from their rotors to stators or vise verse.

A conventional electrical slip ring consists of conductive rings mounted on a rotor and insulated from it. Fixed brushes run in contact with the rings, rubbing against the peripheral surfaces of the rings, transferring electrical power or signals to the stator.

The sliding contact between the rings and brushes during this continuous rotation of the rotor causes the wear on the slip rings and generate heat, even noise in the system. Therefore, even properly operating slip rings require frequent maintenance at significant cost. Sometimes the debris of slip rings causes an electrical insulation breakdown between adjacent circuits.

One of the objectives in the current invention is to eliminate the sliding contacts between brushes and rings. reduce the friction and wear, as well as to minimize the need for maintenance so that the electrical rotary joint not only can work at much higher speed and last much longer, but also it could be used in any harsh environments such as extreme temperatures, vibration, and shock.

Gears are used in a variety of mechanical devices. Gears are toothed members which transmit power/motion between two shafts by meshing without any slippage. If the gears are made of conductive material, they can also transmit electrical signal/power, during their rotational motion. Although there is friction in the gear meshing, the efficiency related to tooth friction losses for single tooth mesh is usually as high as 98˜99.5%. So it is ideal to replace brushes and rings in electrical slip ring with conductive gear meshing.

### BRIEF DESCRIPTION OF THE DRAWINGS

FIG. 1 is an illustration of a simple planetary gear mechanism in current invention;

FIG. 2 is a cross section view of the first preferred embodiment of the current invention;

FIG. 3 shows the cycloidal pin-wheel mechanism of the second preferred embodiment in the current invention;

FIG. 4 is a schematic illustration of the pin-wheel the second preferred embodiment in the current invention.

### DESCRIPTION OF THE INVENTION

A simple planetary or epicyclic gear mechanism consists of a sun gear in the center. an internal or ring gear with a common axis with sun gear, and at least one planet gear. The planet gear is located between the sun gear and ring gear, and meshes with both the sun gear and the ring gear. If the ring gear is stationary, when sun gear rotates, the planet gear not only rotates about its axis, its axis also rotate around the axis of sun gear.

In stead of employing the sliding motion between the ring and the brush in electrical slip ring, the current invention makes use of a plurality of conductive gears, particularly a planetary gear mechanism, to transfer electrical power, and/or signal(s) between relatively rotatable objects.

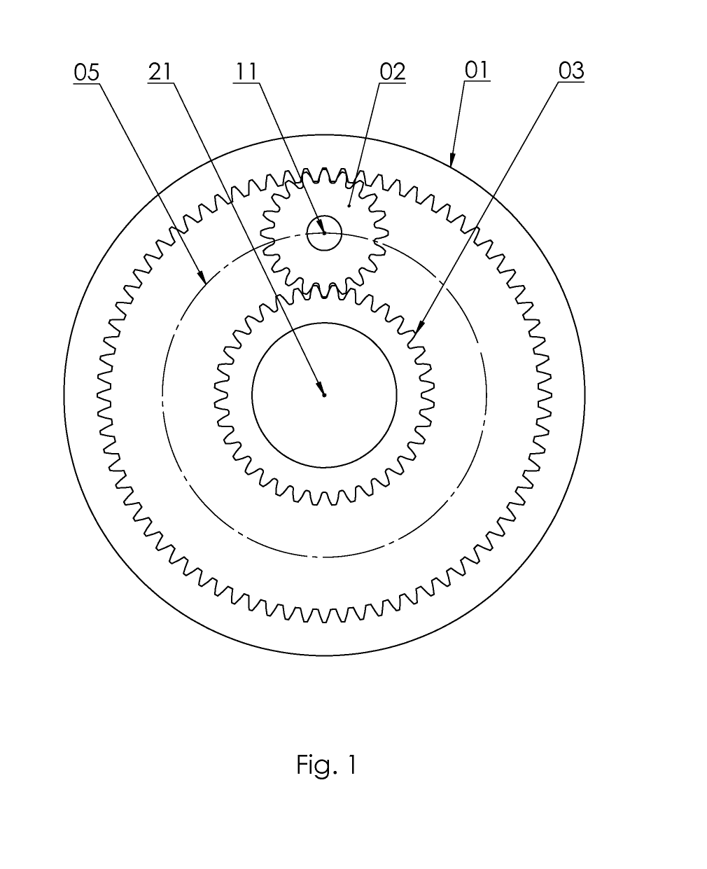

In FIG. 1, a ring gear 01, and a sun gear 03 have a common axis 21. At least one planet gear 02 meshes with both sun gear 03 and ring gear 01. For the illustration purpose. only one planet gear is showed. All the gears are made of conductive material. Circle 05 is the orbit of the planet gear 02.

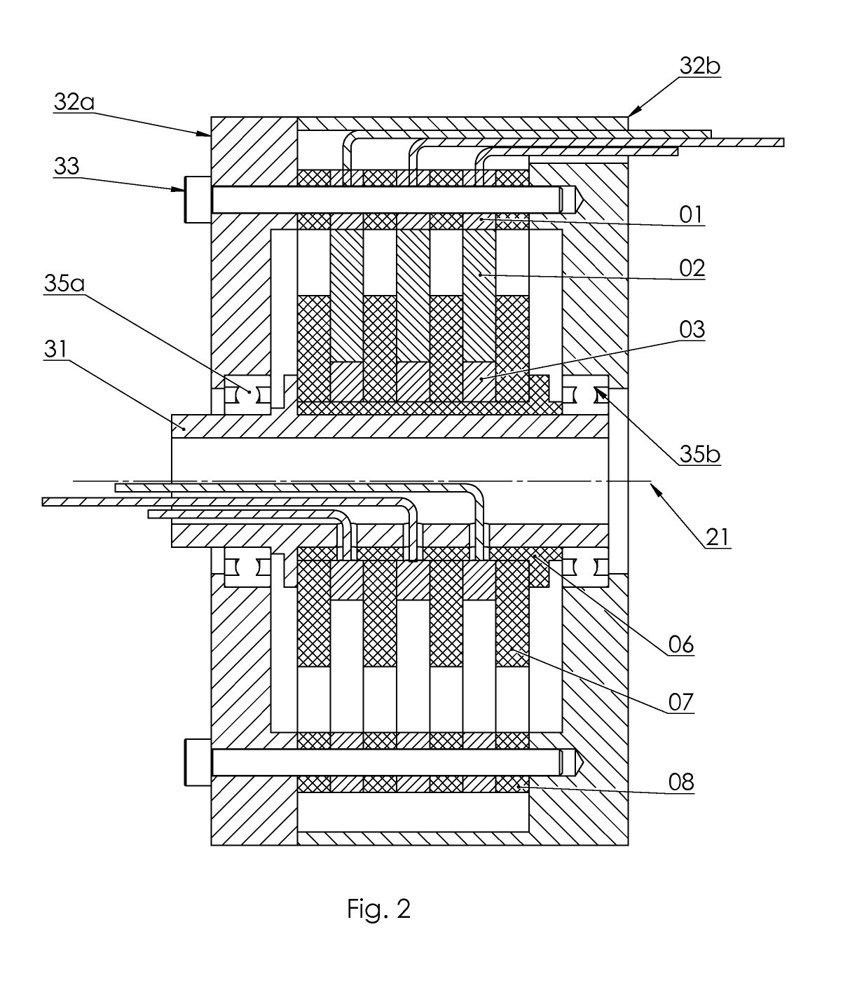

As shown in FIG. 2, a preferred embodiment of the present invention comprises a rotor 31, stator 32a and 32b. A plurality of bolts 32 are used to connect stator 32a and 32b. A pair of bearings 35a and 35b are mounted in the bore of the stator 32a and 32b on the common axis 21 of rotor and stator so that the rotor 31 is able to rotate around the axis 21. This invention can be a multi-channel electrical rotary joint, e.g., multiple sets of ring gear, planetary gear, and sun gear assemblies are stacked in axial direction, layer by layer, to further increase the number of channels provided in the electrical rotary joint. For the illustration purpose, only one channel is marked. The sun gear 03 is attached to the rotor 31 through insulating spacers 07 and insulating cylinder 06. The ring gear 01 is fixed to stator 32a and 32b through insulating spacers 08 and bolts 33. The planet gear 02 is hold in axial position by insulating spacers 07 on both sides. For anti-backlash purpose, the ring gear 01, the sun gear 03 and/or the planet gear 02 is a flex gear. For the purposes of this patent a flex gear shall he considered any gear that shows some degree of flexibility without permanent distortion.

There is a variety of gear tooth profiles available in gear industry. Examples of explanation in current invention include, but are not limited to: involute tooth profile, cycloid tooth profile, and Novikov, Wildhaber or Circular Arc Tooth Profile.

The involute gear profile is the most commonly used in gear industry today. In involute gears, the profiles of the teeth are involutes of a circle. The kinematics of a gear meshing pair with involute profile is best described as rolling/sliding contact with pure rolling at the pitch line. Although there is friction in the gear meshing, the efficiency related to tooth friction losses for single tooth mesh is usually as high as 98˜99%.

In cycloidal gears, the contact takes place between a convex flank and concave surface. This condition results in the mostly rolling contact, larger contact area, and less wear in cycloidal gears. So cycloidal teeth have longer life and it is a better option for electrical rotary joint.

The Novikov gears have circular tooth surfaces. For a meshed gear pair, normally one of the gears has a convex tooth profile and another gear tooth has a concave tooth profile, thus leading to pure rolling action at the contact for these gears. The efficiency for Circular Arc Tooth Profile is as high as 99.5%.

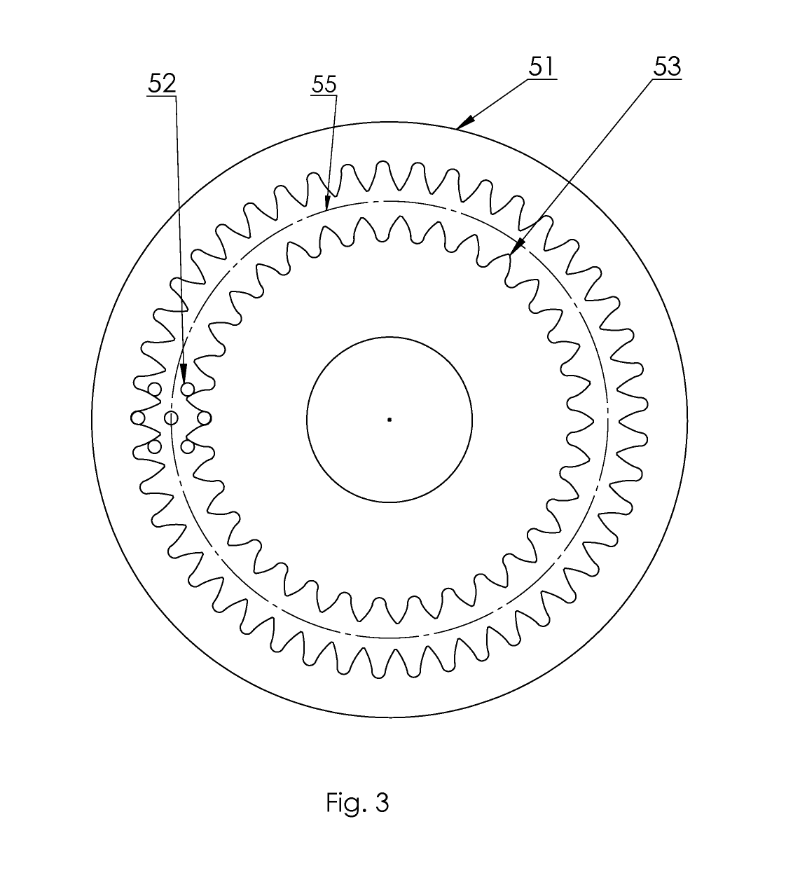

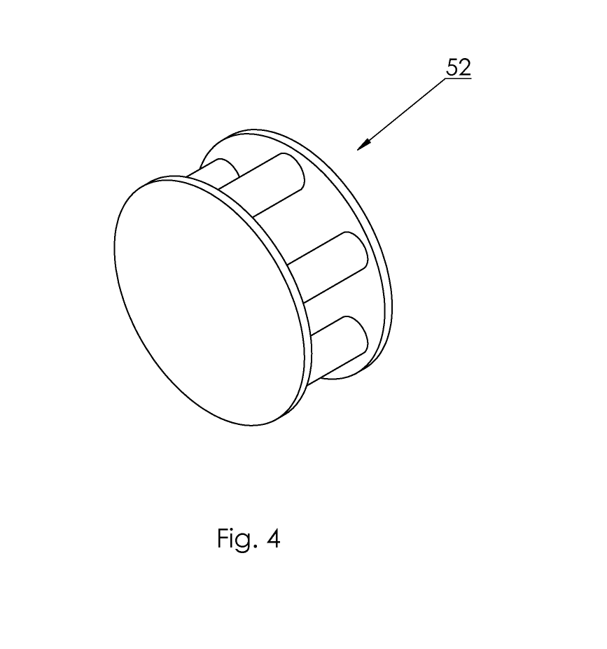

There is another embodiment, illustrated in FIG. 3, of the present invention, wherein a planetary cycloidal pin-wheel mechanism replace the simple planetary gear mechanism in the first embodiment of the invention. Specifically, the plurality of planet gears are substituted by the plurality of conductive pin-wheels 51. As shown in FIG. 4, the pin-wheel 52 consists of two plates connected by a couple of paralleled positioned pins. The planetary cycloidal pin-wheel mechanism consists of the cycloidal sun gear 53 in the center, an internal or ring cycloidal gear 51 with a common axis with sun gear 53, and at least one pin-wheel 52. For illustration purpose, only one pin-wheel is showed. Like the planet gear 02 in FIG. 1, the pin wheel 52 revolves both around the sun gear 53 and on its own axis. 55 is its orbit. All the cycloidal gears and pin-wheels are made of conductive materials.

While two preferred embodiments of the invention have been described using specific terms, such description is for illustrative purposes only, and it is to be understood that changes and variations may be made without departing from the spirit or scope of the claims.

I claim:

1. An apparatus for passing an electrical current and/or signal across a rotating interface consisting:
at least one ring gear made from a material or a composite structure capable of conducting an electrical current;
at least one sun gear made from a material or a composite structure capable of conducting an electrical current;
one or more on planet gear(s) and/or planetary pin-wheel(s) made from a material or a composite structure capable of conducting an electrical current;
wherein said planet gear(s) and/or said planetary pin-wheel(s) are always in contact with at least one said sun gear and one said ring gear, and said ring gear(s) and said sun gear(s) are relatively rotatable about a common axis of rotation; wherein there is no restriction on the teeth profile of said ring gear(s): and wherein said sun gear(s), said planet gear(s) and said pin wheel(s) provided the teeth profiles are capable of meeting the prior two requirements and said sun gear(s), said ring gear(s) and said planet gear(s) may be solid or flex gears.

2. The apparatus of claim 1, further having an electrical current/signal originating at said sun gear(s) will pass the electrical current/signal to said planet gear(s) and/or said planetary pin-wheel(s). which will intern pass the electrical current/signal to said ring gear(s).

3. The apparatus of claim 1, further having an electrical current/signal originating at said ring gear(s) will pass the electrical current/signal to said planet gear(s) and/or said planetary pin-wheel(s). which will intern pass the electrical current/signal to said sun gear(s).

4. A bi-directional single channel electrical slip ring consisting:
a rotor;
a stator;
one or more bearings;
a ring gear all made from a material or a composite structure capable of conducting an electrical current;
a sun gear all made from a material or are a composite structure capable of conducting an electrical current;
one or more planet gear(s) and/or planetary pin-wheel(s) made from a material or a composite structure capable of conducting an electrical current;
wherein said stator is mechanically attached and electrically insulated from said sun gear and said ring gear, and said stator and said rotor are electrically insulated from said planet gear(s) and said planet gear(s) and/or said planetary pin-wheel(s) are insulated each other;
wherein said planet gear(s) and/or said planetary pin-wheel(s) are always in contact with said sun gear and said ring gear; wherein said ring gear and said sun gear rotate with a rotational rate equal to that of said stator and said rotor respectively and said ring gear and said sun gear are relatively rotatable And said ring gear, said sun gear and/or said planet gears may be solid or may be flex gears; and wherein an electrical current/signal originating at said sun gear(s) will pass the electrical current/signal to said planet gear(s) and/or said planetary pin-wheel(s) which will intern pass the electrical current/signal to said ring gear(s) and visa versa.

5. A bi-directional multi-channel electrical slip ring consisting:
a rotor;
a stator;
one or more bearings;
a plurality of ring gear(s) made from a material or a composite structure capable of conducting an electrical current;
a plurality of sun gear(s) all made from a material or a composite structure capable of conducting an electrical current;
a plurality of planet gear(s) and/or planetary pin-wheel(s) made from a material or a composite structure capable of conducting an electrical current;
wherein said stator is mechanically attached and electrically insulated from said sun gear(s), each said sun gear may be electrically insulated from the remaining said sun gear(s), said stator is mechanically attached and electrically insulated from said ring gear(s), and said ring gear may be electrically insulted from the remaining said ring gear(s); wherein said planet gear(s) and/or said planetary pin-wheel(s) are always in contact with said sun gear and said ring gear;
wherein aid stator and said rotor are electrically insulated from said planet gear(s) and said planet gear(s) and/or said planetary pin-wheel(s) are insulated each other, said ring gear(s) and said sun gear(s) rotate with a rotational rate equal to that of said stator and said rotor respectively and said ring gear(s) and said sun gear(s) are relatively rotatable that said ring gear(s), said sun gear(s) and/or said planet gears may be solid or may be flex gears; and
wherein an electrical current/signal originating at one of the said sun gear(s) will pass the electrical current/signal to one or more of the said planet gear(s) and/or said planetary pin-wheel(s) that will intern pass the electrical current/signal to one of the said ring gear(s) and visa versa and each unique electrical path shall be electrically insulted from all other electrical paths.

6. The slip rings according to claim 4, wherein the slip rings may be filled with an incompressible fluid for pressure compensation purposes, to provide electrical insulation, and/or further reduce friction.

7. The slip rings according to claim 5, wherein the slip rings may be filled with an incompressible fluid for pressure compensation purposes, to provide electrical insulation, and/or further reduce friction.
